(19) United States
(12) Patent Application Publication
(10) Pub. No.: US 2024/0044736 A1
(43) Pub. Date: Feb. 8, 2024

(54) SYSTEM AND METHOD FOR DETECTING DAMAGED SPENT FUEL CANISTERS

(71) Applicant: UCHICAGO ARGONNE, LLC, Chicago, IL (US)

(72) Inventors: Yung Y. Liu, Hinsdale, IL (US); Brian Craig, Downers Grove, IL (US); Zenghu Han, Woodridge, IL (US); Hirofumi Takeda, Chiba (JP)

(73) Assignee: UCHICAGO ARGONNE, LLC, Chicago, IL (US)

(21) Appl. No.: 17/879,722

(22) Filed: Aug. 2, 2022

(51) Int. Cl. G01M 3/00

(52) U.S. Cl. CPC G01M 3/002

(57) ABSTRACT

A system for monitoring stored spent fuel rods is provided, the system comprising: canisters containing the spent fuel rods; and temperature measuring means positioned on external surfaces of the canisters. Also provided is a method for monitoring stored spent fuel rods contained in canisters, the method comprising measuring temperature of the canisters at a plurality of external surfaces of each of the canisters, recording time of temperature differences between said external surfaces, determining time of oxidation initiation of the spent fuel rods based on the recording time, and preventing oxidation from occurring.

### CONTRACTUAL ORIGIN OF THE INVENTION

The U.S. Government has rights in this invention pursuant to Contract No. DE-AC02-06CH11357 between the U.S. Department of Energy and UChicago Argonne, LLC, representing Argonne National Laboratory.

### BACKGROUND OF THE INVENTION

### 1. Field of the Invention

This invention relates to storage of spent nuclear fuel and more specifically, the invention relates to a system and method for monitoring spent fuel canisters in storage.

### 2. Background of the Invention

Detection of damaged spend fuel (SF) rods inside a welded canister during dry storage operation has been a challenge to both government and private industry operators. FIG. 14, discussed in more detail infra, depicts a typical configuration for spent fuel rod containment, namely a plurality of fuel rods 2, a canister 4 hermetically sealing the fuel rods from their immediate surroundings, and a cask such as metal or concrete 6 containing the canister 4, while providing channels for passive air cooling and structure for radiation shielding. The casks 6 also confer physical protection (e.g. shock proof protection) to the entire construct.

Spent nuclear fuel may be stored in the dry concrete casks with welded stainless-steel canisters for extended periods. Continuously monitoring the functional and structural integrity of the canisters is exceptionally challenging due to the intense levels of heat and radiation and the difficulty of transmitting sensor signals out through sealed (e.g. welded) canister walls. Yet, confirmation of canister integrity is crucial for aging management of dry cask storage systems for extended long-term storage and subsequent transportation. A canister breach, if undetected early enough for mitigatory actions, can lead to serious consequences, such as release of radioactive contaminants, oxidation of fuel cladding which could compromise fuel-rod integrity and criticality safety, and generation of potentially explosive hydrogen gas.

Chloride-induced stress corrosion cracking (CISCC) of canisters has been identified as a potential degradation mechanism, requiring ageing management—especially in a marine air environment. Investigations into the potential radiological consequences of a through-wall crack in a canister resulting from CISCC can help utilities assess ageing management actions for potential CISCC of welded stainless canisters.

Inasmuch as newly established SF canisters are backfilled with helium gas (for example at approximately 6 atm), helium gas leakage to the environment exterior of the canisters will occur if CISCC penetrates the canister walls. This leakage continues until the pressure difference becomes zero. An example calculation for a HI-STORM MPC (multipurpose canister) showed this duration as 52 days, assuming a crack opening area (COA) of 4E-05 cm².

After the canister interior reaches atmospheric pressure, the helium gas will continue to leak and be gradually replaced with air. This process is driven by the temperature variation of the surrounding atmosphere. In some cases, 90 percent of the helium gas in the canister is replaced with air within a year.

Air ingress into the canister will affect heat removal, resulting in a temperature increase in the SF. Oxidation of SF rods cladding by air at elevated temperature should be avoided. Therefore, pressure drops in the canister caused by leakage due to CISCC should be detected early by monitoring before the internal pressure reaches atmospheric pressure.

Various nondestructive evaluation (NDE) techniques to detect CISCC have been developed by using special devices, including a remote-controlled robot system for a single cask. But such NDE techniques require preparation, special equipment, and risk management of radiation exposure for every inspection. Because accessibility to the welded surface inside some storage modules is limited, managing the effects of cracking may not be practical without additional efforts to retrieve the canister from the storage module or overpack.

A need exists in the art for a system and method for anticipating and detecting gas leakage from canisters containing spent nuclear fuel. The system and method should be conducted remotely, which is to say with little or no physical contact between personnel and the canisters. The system and method should provide an automatic alarm when thresholds of virtual sensors are exceeded. This would afford enough warning to allow rectification of the breach so as to avoid exposure to said personnel or the environment.

### SUMMARY OF INVENTION

An object of the invention is to provide a system and method for detecting spent nuclear fuel canister leaks that overcome many of the drawbacks of prior art.

Another object of the invention is to provide a system and method for anticipating spent nuclear fuel leaks in storage canisters. A feature of the invention is determining the thermal-physical properties of gas mixtures inside the canisters by comparing changes of temperatures at locations outside of the canister, for example solely on exterior surfaces of the canister. An advantage of the invention is to ensure timely detection of a potential breach of the canister confinement boundary.

Yet another object of the invention is to provide a system and method for detecting breaches of spent fuel rods encapsulated within canisters. A feature of the invention is monitoring the surface temperatures of sealed (e.g., welded) containers. An advantage is that canister breach can be detected before fuel oxidation occurs. Another advantage of the invention is that the canister breach can be detected well within regulatory leakage limits.

Still another object of the invention is to provide a canister gas-leak detection system. A feature of the invention is monitoring canister surface temperatures using a remote area modular monitoring (RAMM) system. An advantage of the invention is that the canister is remotely “examined” and not modified, opened or otherwise physically handled. This assures safety to monitoring personnel.

The invention provides a system for monitoring stored spent fuel rods, the system comprising a canister defining an internal environment containing the spent fuel rods; temperature sensors to continuously measure the surface temperatures of the canister; and an algorithm equating the surface temperatures to the physical and thermal-hydraulic characteristics of the internal environment.

Also provided is a method for monitoring stored spent fuel rods contained in canisters, the method comprising measuring temperature of the canisters at a plurality of external surfaces of each of the canisters; recording time of temperature differences between said external surfaces; determining time of oxidation initiation of the spent fuel rods based on the recording time; and preventing oxidation from occurring.

### BRIEF DESCRIPTION OF DRAWING

The invention together with the above and other objects and advantages will be best understood from the following detailed description of the preferred embodiment of the invention shown in the accompanying drawings, wherein:

FIG. 1 is a graph showing canister outgassing as a function of time, in accordance with features of the present invention;

FIG. 2 is a flow chart showing steps of the invented method, in accordance with features of the present invention;

FIG. 3 is a flow chart showing features of the remote sensing system, in accordance with features of the present invention;

FIG. 4 depicts the application software architecture and hardware interface of a single RAMM unit, in accordance with features of the invention;

FIG. 5 depicts the virtual sensor creation screen in the invented RAMM-TM;

FIG. 6 depicts an exemplary virtual sensor design;

FIG. 7 depicts physical sensor data being read by the RAMM-TM main app;

FIG. 8 depicts the data being processed and sent to a remote server 20;

FIG. 9 depicts a recalculation of virtual sensors;

FIG. 10 shows the computations for the virtual sensors executed and a topologically sorted order;

FIG. 11 shows data being moved from the sandbox;

FIG. 12 depicts data viewable from the user interface;

FIG. 13 is a graph showing helium leakage from a canister over time; and

FIG. 14 is a depiction of thermocouple positions on a spent fuel dry cask storage system, in accordance with features of the present invention.

### DETAILED DESCRIPTION OF THE INVENTION

The foregoing summary, as well as the following detailed description of certain embodiments of the present invention, will be better understood when read in conjunction with the appended drawings.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Heat from spent nuclear fuel rods stored inside their canisters is dissipated (removed) by conduction, convection and radiation. Natural convection dominates due to gas flow channels inside the canister. The thermal-physical properties, e.g., density, thermal conductivity, and viscosity of gas species (He, air, Kr-85) depends on pressure, temperature. These changes affect the canister outer surface temperatures.

The change of temperature difference (DTBT), particularly at the center top and bottom of the canister, is >20 C when the air pressure inside a canister drops from 6 atm to 1 atm at end of canister leakage. This occurs in dry cask storage systems because the flow medium is gas.

This invention meets the need of managing radiological consequences following a spent fuel rod canister breach caused by CISCC during dry storage. Government and industry organizations around the world involved in dry storage of spent nuclear fuel in canisters will benefit from this invention.

Specifically, the invention continuously monitors the chemical, physical and thermal hydraulics characteristics of spent nuclear fuel canisters. An aspect of the invention utilizes surface temperatures of the canisters to determine thermal (and therefore chemical) changes in gases within the canisters and therefore the extent of any physical damage to fuel cladding. In an embodiment of the invention, temperature probes contact a plurality of points of the canister's exterior surface. The inventors have considered the actual surface to be the most reliable temperature indication point. Vent inlet and outlet temperatures associated with the vents of the containment housing within which the canisters reside can be utilized as ancillary points of data collection. However, inasmuch as vent inlet and outlet structures are subject to ambient factors (e.g. weather, time of day, season), data taken from these points should be construed as environmentally-effected data readings, compared to data derived directly from physical contact with exterior surfaces of the canisters. This is because the canister surfaces are not in direct fluid communication with ambient conditions (e.g., such as pressure, humidity, temperature, sunlight, physical contact with other physical structures, etc.).

An exemplary chemical change that occurs over time within spent fuel canisters is that of isotope/air mixtures inside the canister environment. One such isotope is fission gas krypton-85 (Kr-85). The relevance of a Kr-85/air concentration changes is discussed infra.

Detection of changes in other chemical moieties relative to air or any backfilled inert gas (e.g. helium) is also relevant, not only to spent fuel rod monitoring, but to other industries as well. For example, instances where monitoring of chemical and physical changes in hazardous enclosures is relevant include nuclear reactor sarcophagi, chemical manufacture, food processing, and combustion scenarios. Take the production of hydrogen gas: as the amount of H₂ increases over time within an enclosure, its ratio within the entire enclosed atmosphere therefore changes. Changes in heat transfer processes occur, with signatures manifested by the change in surface temperatures. In canister paradigms, those changes occur in at least two different locations, with top and bottom center locations being most indicative. Other surface temperature monitoring locations (for example along the sides of the canister at perhaps mid-point) may be less sensitive to detect an initial canister breach but nevertheless provide confirmation of said breach.

An embodiment of the invention utilizes a plurality of “virtual sensors,” based on physics, STAR-CCM+ high-performance computing simulation, and temporal-spatial temperature data that are validated in scale-model mixed-gas experiments, to anticipate spent fuel cladding failures, or provide early detection of same. (STAR-CCM+ is a commercial Computational Fluid Dynamics (CFD) based simulation software developed by Siemens Digital Industries Software.) The invention provides a system and method for anticipating cladding failure and its subsequent spent nuclear fuel oxidation weeks before oxidation actually begins. A salient feature of the invention is using a temperature-difference monitoring method to detect physical or chemical changes within a spent nuclear fuel canister.

A myriad of events may trigger a canister breach. As discussed supra, pressure drops within a canister begin upon CISCC corrosion to the outside. A canister breach also may be caused by a tip-over during earthquakes, or during loading or unloading at repository sites or on transport vehicles. The size of these physical jostling type of breaches maybe larger than CISCC corrosion-induced breaches but the effects are the same. It is also possible that CISCC initially causes partial through-wall penetration; which is exacerbated by tip-overs or other instances.

The invention detects damaged SF rods inside a welded canister following a canister breach and then automatically triggers an alarm when the thresholds of virtual sensors are exceeded. This provides time to anticipate, prevent and/or mitigate damage to the environment and/or exposure to personnel. For example, changes in surface temperatures at the top and bottom of the canister (ΔTBT) during gas leakage (depressurization) may trigger automatic alarms, providing an audio and/or visual basis for early detection of gas leakage from the canister. In an embodiment of an app for detection, alarms are shown on a web page. Chemical, thermal, and/or thermal hydraulic status changes may be indicated via color changes (for example the virtual sensors turning from green to red, for example, or grey to black, as depicted in FIG. 13. To authorized personnel, the status changes may also be sent by email and/or SMS.

The total amount of heat in the canister that needs dissipation decreases as spent fuel decays over time. It can dissipate out from the top, side, and bottom of the canister, each of which has different boundary conditions. The bottom of the canister always contacts solid ground such that heat transfer only occurs by conduction. Therefore, compared to other parts of the canister not in contact with adjacent structures, the temperature at the bottom center of the canister is generally higher during gas leakage than elsewhere on the canister surface.

Conversely, heat transfer from the top and side of the canister is dominated by convection inside and outside the canister. (Conduction through gas phase only plays a minor role.) The inventors have determined that temperature differences within a single canister are due to the top of the canister not in contact with any surrounding structures, and therefore lacking any insulation or other hinderances which would otherwise prevent heat loss to the surroundings. By contrast, the bottom of the canister does contact or is otherwise surrounded or embedded in support material so as to be insulated and therefore less likely to shed its heat to surrounding structure.

Temperature variances as small, or smaller than 2 degrees celsius (° C.) between the ends of the spent fuel rod canister can be detected. (2° C. is 10 times the inherent uncertainties of Type K thermocouple temperature measurements, ±0.2 C.) For example, the thresholds can be “dynamically” adjusted during the gas leakage experiments, so that a 1 degree variance detection is possible. Detection of such a narrower temperature difference would concomitantly reduce the time to detect leakage.

Temperature measurements may be made at any time interval considered relevant by operating personnel depending on the technology being monitored (e.g., every 60 seconds) and from each sensor, or from selected sensors.

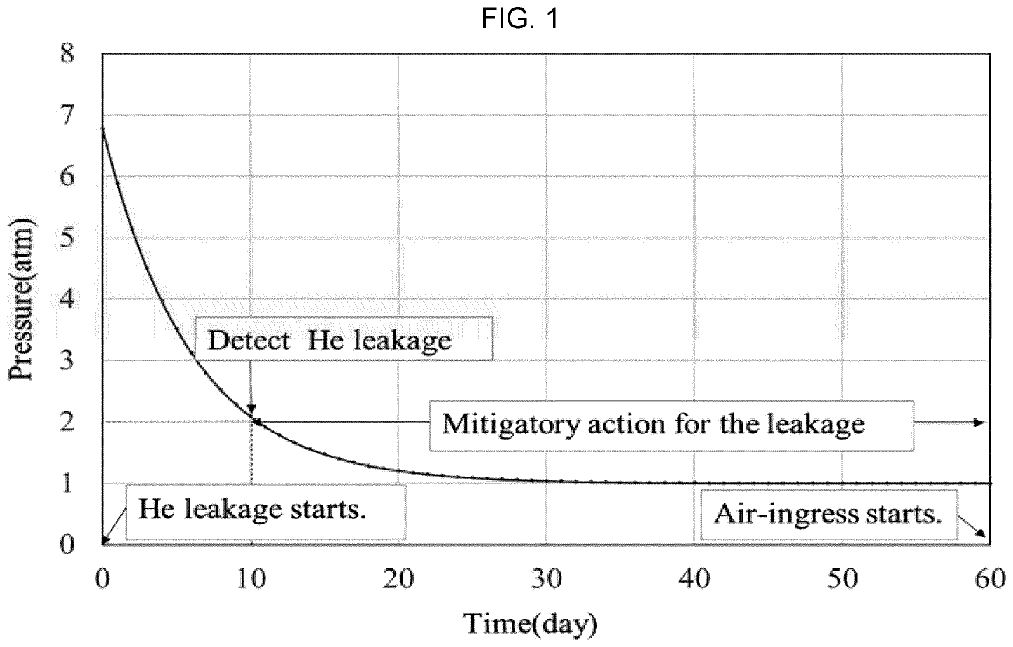

FIG. 1 shows canister pressure drop with time due to CISCC (reproduced with reference to the results of leakage analysis). The graph shows that when pressure drops within a canister are detected 10 days after leakage begins, action could be taken in the next 40-50 days to avoid air ingress into the canister; this, to prevent spent fuel oxidation. Given no air ingress during this period of time, no radiological exposure or other consequences due to helium leakage from the canister would occur.

An indicator of damaged spent fuel with cladding breach inside a canister is the presence of Kr-85, which is a prominent fission gas product and a βγ emitter (687 keV) with a fission yield of 0.218% and a half-life of 10.76 yr. A mixture of Kr-85 and air after a CISCC-induced canister breach will affect heat transfer in the canister and, as a result, the canister's external surface temperatures. The extent of the impact on heat transfer depends on the thermal-physical properties of the gas mixture determined by the percent of damaged SF rods.

Remote Area Modular Monitoring (RAMM) for canister surface temperature measurement (RAMM-TM), and Computation Fluid Dynamics based software (e.g., STAR-CCM+ available from Siemens) simulation of mixed-gas heat transfer in the canister are two components of the invented system for detecting damaged SF rods inside a welded canister during dry storage. When combined, these systems can indicate extent of cladding compromise using temperature data alone.

RAMM-TM contains several innovative features, and multiple firmware modules were developed for a customized RAMM-TM. FIG. 2 depicts the aforementioned firmware modules, which include the following components:
1. A sensor monitor module 14 that monitors the sensor peripherals (e.g., the physical sensors 12 such as thermocouples, accelerometers, hygrometers (for humidity), and solid state radiation sensors (for gamma and neutron radiation), which are gathering the empirical data and checking alarm status;
2. A communication module 16 that receives the sensor information from the sensor monitor module and sends the information, including alarms, to data servers 18, 20;
3. One of the aforementioned data server modules 18 “mimics” the central server 20 that receives the sensor information from the communication module and stores the data locally, for example on a single board computer 26 (also referred to as the motherboard in the computer arts) of the RAMM-TM unit. The local data server 18 also connects to a local user interface module 22 to allow for displaying the locally stored data;
4. The aforementioned user interface module 22 provides access to the local data server module, allowing users to adjust the settings of the temperature alarm thresholds for the “virtual” sensors 24. The virtual sensors 24 are analytic functions, the values of which are derived from calculations based on the measured temperatures of the physical sensors 12. The user can therefore determine the level of diligence she seeks by choosing and assembling a database of values, (e.g., pressure values, oxidation and other chemical products (gaseous, liquid), etc.). For example, pressure is linked to leakage. Pressure is also linked to multi-component gas mixtures. Changes in relative proportions of gas species over time could be indicative of potential for oxidation. Any of these data points would be indicative of pre-leakage states, or, conversely, acceptable conditions. Predetermined physical responses may also be implemented based on how widely actual physical parameters vary from ideal conditions. This is an application of high level function (HOF) is discussed infra. HOF takes one or more functions as arguments (i.e. procedural parameters) which is a parameter of a procedure.

The analytical functions for the virtual sensors 24 are derived on the basis of physics, aided by CFD (e.g., STAR-CCM+) simulations of mixed-gas temperature, density, and flow fields. The so evolved virtual sensors 24 could be linear, higher order, or even reduced order, based on large data and machine learning.

### Virtual Sensor

### Creation Detail

Creation of a virtual sensor includes naming the sensor, an equation or algorithm to virtualize data points based on granular (i.e., empirical or actual) data, and a list of dependent physical sensors providing that data. Such algorithms are available via the Applicant's DeepHyper™ distributed machine learning (AutoML) package available at (https://deephyper.readthedocs.io/ent/latest/) at Argonne National Laboratory. It comprises different tools such as:
Optimizing hyper-parameters for a given black-box function;
Neural architecture search to discover high-performing deep neural network with variable operations and connections. (Neural networks comprise computer architecture in which a number of processors are interconnected in a manner suggestive of the connections between neurons in a human brain and which is able to learn by a process of trial and error. —called also neural net. These algorithms automate the development of deep neural networks for scientific applications.); and
Automated machine learning, to experiment with many learning algorithms from Scikit-Learn. (Scikit-learn is a free software machine learning library for the Python programming language. It features various classification, regression and clustering algorithms including support-vector machines. random forests, gradient boosting, k-means and DBSCAN, and is designed to interoperate with the Python numerical and scientific libraries NumPy and SciPy.)

DeepHyper provides an infrastructure that targets experimental research in NAS and HPS methods, scalability, and portability across diverse supercomputers. It comprises three main modules:
Deephyper.problems: Tools for defining neural architecture and hyper-parameter search problems.
deephyper.evaluator: A simple interface to dispatch model evaluation tasks. Implementations range from subprocesses for laptop experiments to ray for large-scale runs on HPC systems.
deephyper.search: Search methods for relevant research organisations such as the National Academy of Science (NAS) and the Heavy Photon Search (HPS) experiment. By extending the generic Search class, one can easily add new NAS or HPS methods to DeepHyper.

The invention derives algorithms and hyperparameters from data to evolve a set of the “virtual sensors, or analytical functions (including linear, higher order, or reduced order), determined on the basis of STAR-CCM+ high-performance computing simulation, and temporal-spatial temperature data that are validated in the scale-model mixed-gas experiments, for which data is provided herein.

The virtual sensors are user defined JavaScript code that is executed by the RAMM-TM application. The RAMM-TM application uses a sandbox approach to isolate the user defined code such that it will not affect operations of the other parts of the RAMM-TM application (also written in JavaScript). (In software development parlance, a sandbox is a testing environment that isolates untested code changes and outright experimentation from the production environment or repository. Sandboxing protects “live” servers and their data, vetted source code distributions, and other collections of code, data and/or content, proprietary or public, from changes that could be damaging to a mission-critical system or which could simply be difficult to reverse.)

The sandbox (element 58 in FIGS. 7-13) is initialized via a JavaScript object which contains the initial state of the sandbox. The object is updated to include the latest physical and virtual sensor values at the time of calculation.

Specific JavaScript functionality has been removed to prevent the user defined code from affecting the system outside of the sandbox. As such, the algorithm is defined by the users and limited to basic JavaScript.

RAMM-TM supports calculations defined by using basic JavaScript, and the values of virtual sensors are updated any time a new sensor reading is received from a physical sensor indicated as a dependent. Each virtual sensor has adjustable thresholds (Min and Max) that, when violated, will trigger an alarm.

For the series of scale model canister gas-leakage experiments, DTBT (difference in temperature bottom and top) is the primary virtual sensor for leakage detection. However, and as discussed supra, a plurality of ancillary sensors may be included, for example, DTBTIN (difference in temperature between (TB) virtual sensor, and inlet, IN, positions).

The RAMM-TM unit 20 also embodies the edge computing paradigm as a distributed sensing and computing system that brings computation and data storage closer to the sources of data. This shortens response times and saves bandwidth in future applications to actual dry cask storage systems.

FIG. 3 is a functional block diagram showing the hardware architecture design of a RAMM unit. Dashed lines indicate data flow. Solid lines indicate power flow. Serial Peripheral Interface is designated by SPI. Universal Serial Bus is designated as USB. Embedded Multi-Medial Controller is designated as eMMC. As depicted in FIG. 3, the SBC 26 has eMMC Memory and DDRS Memory. The Universal Asynchronous Receiver-Transmitter is designated as UART.

Each RAMM unit consists of 4 main components:
1. A single board (i.e. motherboard) computer (SBC) 26;
2. Sensor modules 28 for multiple sensor daughter boards;
3. Communication modules 30 for various communication media (SmartMesh) 32, cellular modem with global positioning system [GPS] 34, satellite modem 36, and 10/100/1000 Base-T PHY) 38; and
4. A power supply system 40 (e.g., IEEE 802.3at controller with flyback regulators 42, regulator for various voltages 44. and rechargeable batteries 46).

The modular design makes a RAMM unit adaptable to existing applications and expandable for system development and future applications. The SBC is the controller of the RAMM unit that consists of an ARM A8 core processor and embedded multi-media controller (eMMC) chipset with 4 GB flash memory and high-speed, dynamic random access memory DDR3. The abundant computational resources make it possible to support a full-blown operation system (OS) on the SBC.

An embodiment of the invention uses open source Ubuntu™ as the OS of the SBC. (Ubuntu™ is a Linux distribution based on Debiean and composed mostly of free and open source software.) It has ported a set of interface drivers enabling control of various options for peripherals in the SBC—including a Serial Peripheral Interface (SPI), a Universal Serial Bus (USB), an Inter-Integrated Circuit (I2C) for the surface-mounted stock sensors, a Universal Asynchronous Receiver/Transmitter (UART), and Ethernet. The OS also contains tools that support remote application debugging, which facilitates embedded code development for RAMM.

Customized firmware drivers have been written for the SBC to manage the various interfaces between the sensor and communication modules and the power supply system, where the power and data flows are indicated by the solid- and dashed-lines, respectively, in FIG. 3.

FIG. 4 depicts the application software architecture and hardware interface of a single RAMM unit. A major portion of the Main Module layer (element 28 in FIG. 3) is built using functions ported by the Hardware Drivers layer below it in the software architecture hierarchy. For example, the hardware driver for the satellite modem 36 contains functions that enable a RAMM-TM unit to connect to the satellite modem 36 using the UART protocol, whereas the drivers for the sensor daughter boards 28 contain functions that connect the Main Module code to two SPI ports of the SBC 26, through which the Main Module can collect data from the sensor daughter boards 28. The Main Module also uses the SPI ports to send commands to the sensor daughter boards to configure their operation parameters, such as sensor thresholds.

The two-layer application software architecture is designed to make the RAMM system robust and flexible enough to accommodate the evolving needs of future applications. While the Main Module may need to be modified for new application environments, the functions in the hardware drivers remain unchanged. Both the Main Module and the Hardware Drivers software are written in ANSI C++ language. An Eclipse integrated development environment (IDE) is used for code development with a remote debugger.

Stock sensors 12 in RAMM-TM include temperature (via thermistors), humidity, light, and a 3-axis digital accelerometer. Specialty sensors in RAMM include thermocouples, radiation (gamma, neutron) sensors, electronic loop seal, and a digital camera. While only thermocouple temperature sensors were utilized in the following example, other sensors are also applicable, including radiation sensors that detect Kr-85 (confirm leakage and release of fission product) and 3-axis accelerometer that detects presence of earthquakes.

FIG. 5 depicts the virtual sensor creation screen in the invented RAMM-TM. A virtual sensor name 52 is selected. This name 52 will then appear on the main display. The name 52 is specific for each sensor. It is the origin for all the DTBT, etc.

A virtual sensor equation 54 is inputted to the RAMM-TM. This equation 54 defines any computation required to calculate the value of the virtual sensor. The language used to define the computation is JavaScript.

A list of virtual sensor dependencies 56 are also inputted. It is here where the operator lists all sensors, physical or virtual, upon which the computation depends. These dependencies are used to determine when to update the value of the virtual sensor. The virtual sensor only updates when one of the dependencies updates.

FIG. 6 depicts an exemplary virtual sensor design. Five physical sensors 12 are shown; Temperatures T1-T4 and Relative Humidity RH.

Also shown are two virtual sensors 24. DT1T2 is a virtual sensor that depends on the value of physical sensors T1 and T2. LEAK1 is a virtual sensor that depends on the value of physical sensor RH and virtual sensor DT1T2. DT1T2 will be recalculated any time the values of T1 or T2 are updated.

LEAK1 will be recalculated any time the values of RH or DT1T2 are updated. Thus, LEAK1 will be recalculated whenever T1 or T2 are updated as well.

FIGS. 7-12 are schematic depictions of an exemplary data input and response of the invented system. FIG. 7 depicts new physical sensor data being read by the RAMM-TM main app.

FIG. 8 depicts the data being processed and sent to the remote server 20. These data are also stored in internal data storage embodied in the eMMC Memory and DDRS memory of SBC 26.

The data input depicted in FIG. 8 triggers a recalculation of the virtual sensors, as depicted in FIG. 9. This recalculation is based on the specified dependencies. Step 1 is to copy the current sensor data from the internal data storage into the virtual sensor sandbox, which will allow the calculation of the virtual sensors.

FIG. 10 shows the computations for the virtual sensors executed and a topologically sorted order. This ensures that all dependencies are met before an attempt to calculate. Once a virtual sensor value has been calculated, the results are stored back into the virtual sensor sandbox.

FIG. 11 shows the data being moved from the sandbox to the internal data storage cache, and simultaneously being sent to the remote server 20.

FIG. 12 depicts the data viewable from the user interface.

### Example

The development of RAMM-TM for the detection of gas leakage from a canister was undertaken. Gas leakage was indicated by differences in surface temperatures measured during a series of gas-leakage experiments using a 1/4.5-scale model cask.

The graph depicted in FIG. 13 shows detection of canister helium gas leakage (depressurization from 6 atmospheres, atm). Detection was based on the differences in surface temperatures measured at the canister center bottom and center top, δTBT (T5−T1), for a heat rate corresponding to 10 kW of an actual storage canister after 40 years of dry storage.

He gas-leakage depressurization started at 4:30 p.m. on Day 1 and δTBT (T5−T1) began to rise. An alarm was triggered after the temperature difference exceeded a threshold of 2° C. at 7:30 p.m., about 3 h after the leakage depressurization began. Similar examples are found in a series of experiments for detection of gas leakage under various combination of testing parameters, such as heat rates, simulated CISCC crack size, etc. Each gas leakage experiment took 7 to 11 days, because of the pre-conditioning and slow pressure drop. DTBT alarms, with 2° C. threshold, only a few hours after leakage occurred was common and more than adequate for purpose of early detection within regulatory guidelines.

The multi-physics code STAR-CCM+ was used in the thermal hydraulics modeling to provide computational data as to the temperature, gas density, and flow fields of the scale-model experiments. Validation of the simulation results against actual temperature data was made, that actual data represented the end states of initial and final pressures (before and after completion of the leakage (i.e., depressurizaton) of each gas leakage experiments, with different heat rate, single gas presence (He, or air), and “equivalent” CISCC pinhole diameters for a multi-purpose canister (MPC) of an actual dry cask storage system. (As noted supra, other moieties may also be virtually monitored, for example H₂, Xe and Kr, depending on the application and/or the fuel sequestered.)

The data was subsequently assembled in a database to provide before and after event timelines for thermal hydraulic profiles to provide a monitoring aid, which temperature profiling will confirm being the result of gas leakage. In summary of this point, temperature differences determined virtually and confirmed empirically, are used to diagnose chemical and physical conditions within the canister without breaching the canister.

On the basis of the similarity law of the thermal-hydraulics phenomenon, the scale-model cask utilized electric heaters to simulate the decay heat load of spent fuel assemblies in dry storage for up to 90 years, with independent control of the corresponding fill-gas pressure inside the canister. The scale-model cask experiments also utilized a method to simulate a small canister breach resulting from chloride-induced stress corrosion cracking (CISCC), with a valve controlling gas leakage and canister depressurization, all under specified conditions.

FIG. 14 is a schematic depiction of eight RAMM-TM thermocouple (TC) connections 48 to a 1/4.5 scale model canister 4. The superior and inferior ends 50 of the canister may contain a plurality of TCs, 48, in accordance with features of the present invention. Several of the thermocouples TC2, TC4, TC8 are shown directly contacting the canister's exterior surface along one of its longitudinally extending sides. Eight thermocouples (TC1-TC8) are shown.

The values of the two virtual sensors “DTBTIN” and “DTBT” are the differences between temperatures measured by TC5 (bottom center) and TC6 (inlet vent) and by TC5 and TC1 (top center), respectively.

Table 1 below shows terminal values of measured temperatures by TC1-TC8 before and after completion of a typical gas leakage experiment that lasted 11 days. (“Terminal Values” comprise data points collected before and after completion of the gas leakage experiment when canister pressure dropped from 6 atm to 1 am.) The locations of TC1-TC8 are shown in FIG. 14.

Table 1 data show actual (not virtual) sensor readings. The heat rate in the experiment corresponded to an actual canister breach, wherein the canister stored spent fuel after 40 years of dry storage.

TABLE 1
Thermocouple Readings of terminal values before and
after completion of a typical gas leakage experiment
conducted using the 1/4.5 scale model flask.

| Thermocouple | Before | After |
|---|---|---|
| TC1 | 100.0 | 87.4 |
| TC2 | 91.6 | 86.2 |
| TC3 | 64.0 | 61.0 |
| TC4 | 86.0 | 84.2 |
| TC5 | 95.0 | 108.2 |
| TC6 | 28.4 | 27.3 |
| TC7 | 58.5 | 54.6 |
| TC8 | 90.0 | 87.0 |

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Specifically, a gamma radiation sensor in the RAMM-TM module will provide daughter isotope (e.g., Kr-85) detection capability in dry cask storage systems. A Kr-85 release from a breached canister would confirm the presence of damaged SF cladding and prompted mitigatory actions.

While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all sub-ratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

The embodiment of the invention in which an exclusive property or privilege is claimed is defined as follows:

1. A system for monitoring stored spent fuel rods, the system comprising:
a) a canister defining an internal environment containing the spent fuel rods;
b) temperature measuring devices to continually measure temperatures of the canister; and
c) a database to correlate the temperatures with characteristics of the internal environment.

2. The system as recited in claim 1 wherein the temperature measuring devices are positioned solely on the exterior surfaces of the canisters.

3. The system as recited in claim 1 further comprising a database equating canister surface temperatures to the chemical composition of the internal environment.

4. The system as recited in claim 3 wherein the database comprises data provided by virtual sensors.

5. The system as recited in claim 4 wherein the virtual sensors are based on actual temperature readings, fluid dynamics simulation, and machine learning.

6. The system as recited in claim 3 wherein the internal environment comprises a mixture of gaseous isotope and air.

7. The system as recited in claim 3 further comprising an algorithm utilizing the database for determining the extent of physical damage to the fuel rods based on temperatures of the canister.

8. The system as recited in claim 6 wherein the gaseous isotope is krypton-85 and the temperature difference varies with concentration of the krypton-85.

9. The system as recited in claim 5 wherein the ranges of the virtual sensors are based on detection limits chosen by operating personnel.

10. A method for monitoring stored spent fuel rods contained in a canister, the method comprising:
a) measuring temperature differences at a plurality of external surfaces of the canister;
b) recording time of temperature differences between said external surfaces;
c) determining time of chemical and physical changes of the spent fuel rods based on the recording time; and
d) preventing the changes from occurring.

11. The method as recited in claim 10 wherein the temperature differences are approximately two degrees.

12. The method as recited in claim 10 wherein a first external surface is located at a first superior end of the canister and a second external surface is located at a depending end of the canister.

13. The method as recited in claim 10 wherein the chemical changes include increases in gaseous moiety/air mixture concentrations.

14. The method as recited in claim 13 wherein the moiety is an element selected from the group consisting of helium, krypton, xenon, hydrogen, nitrogen, argon and combinations thereof.

15. The method as recited in claim 10 wherein temperature differences between a first end and second end of the canisters are determined.

16. The method as recited in claim 10 wherein the step of determining the time of chemical and physical changes comprises review of a database correlating change in temperature differences with an algorithm-derived time line.

17. The method as recited in claim 16 wherein the time line predates and postdates the recording time of temperature differences.

18. The method as recited in claim 17 wherein time until exposure to personnel at boundaries of a depository site is determined.

19. The method as recited in claim 17 wherein geologic characteristics of the depository site are contained in the database.

20. The method as recited in claim 16 wherein the algorithm is developed via publically distributed machine learning software.
